(19) United States
(12) Patent Application Publication
(10) Pub. No.: US 2003/0139212 A1
(43) Pub. Date: Jul. 24, 2003

(54) Lottery system and method

(75) Inventor: Stanley E. Fulton, Las Vegas, NV (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: Lotto World, L.L.C., Las Vegas, NV (US)

(21) Appl. No.: 10/335,758

(22) Filed: Dec. 31, 2002

Related U.S. Application Data
(60) Provisional application No. 60/352,126, filed on Jan. 24, 2002.

(51) Int. Cl. A63F 13/00

(52) U.S. Cl. 463/17

(57) ABSTRACT

A method for playing a lottery game is provided which includes the steps of assigning a designated base value for lottery tickets sold wherein the designated base value is based on a base currency valuation, periodically assigning a local ticket value for lottery tickets sold in each of a plurality of jurisdictions, each jurisdiction having a different monetary system, each local lottery ticket value having a value in local currency that is equivalent to the designated base value, and purchasing local lottery tickets in local currency in each of the plurality of jurisdictions. The step of periodically assigning a local ticket value accounts for variations in currency exchange rates.

### CROSS-REFERENCE TO RELATED APPLICATION

This application claims the benefit of U.S. Provisional Patent Application Serial No. 60/352,126, entitled Lottery System, filed Jan. 24, 2002.

### BACKGROUND OF THE INVENTION

1. Field of Invention

This invention relates to an electronic system for selling lottery tickets. More particularly, the present invention is directed to a customer operated lottery ticket sales system which accepts legal tender, credit media and the like, and produces a lottery ticket based on input by the customer.

2. Description of Related Art

In the past, the public had to purchase their lottery tickets at central locations that were operated by employees. In such “traditional” lottery games, lottery players walked into convenience stores, newsstands, or the like, manually entered number selections on selection slips, and provided cash or credit cards to a lottery operator who then entered the selections into a lottery terminal. This lottery terminal electronically connected to a central lottery system, for example, a state system, which managed the lottery games. The central game system then issued a lottery ticket, and the lottery ticket was delivered to the lottery players through the local lottery terminal at the retailer.

Around the world, lottery systems were typically limited in geographic scope. For example, in the United States, the various existing lottery systems are limited to state lotteries and multi-state lotteries. It would be desirable to have a lottery system that allows play for one or more common global jackpots wherein all purchasers of tickets in all monetary systems have substantially the same odds (i.e., the ratio of the purchase price of the ticket to the jackpot) to win the common global (multi-jurisdictional) jackpot.

Additionally, it would also be desirable to provide devices that have the excitement of electronic gaming machines while adhering to standard lottery principles.

### BRIEF DESCRIPTION OF SEVERAL VIEWS OF THE DRAWINGS

The invention will be described in conjunction with the following drawings wherein like reference numerals designate like elements throughout the several views and wherein:

FIG. 1 is a simplified schematic diagram of a lottery system in accordance with one preferred embodiment of the present invention; and

FIG. 2 is a simplified diagram of a player terminal for the lottery system of FIG. 1.

### SUMMARY OF THE INVENTION

A method for playing a multi-jurisdictional lottery game is provided which includes the steps of assigning a designated base value for lottery tickets sold wherein the designated base value is based on a base currency valuation, periodically assigning a local ticket value for lottery tickets sold in each of a plurality of jurisdictions, each jurisdiction having a different monetary system, each local lottery ticket value having a value in local currency that is equivalent to the designated base value, and purchasing local lottery tickets in local currency in each of the plurality of jurisdictions. The step of periodically assigning a local ticket value accounts for variations in currency exchange rates. The step of purchasing lottery tickets may be for a single, multi-jurisdictional lottery utilizing a plurality of local currencies. Alternatively, the step of selling lottery tickets for a common set of lottery jackpots.

A first alternate embodiment of the method for playing a multi-jurisdictional lottery game first includes the step of assigning a designated base value for lottery tickets sold wherein the designated base value is based on a base currency valuation. The method then includes the step of periodically assigning a local ticket value for lottery tickets sold in each of a plurality of jurisdictions where each jurisdiction has a different monetary system and each local lottery ticket value has a value in local currency that is not equivalent to the designated base value. The method further includes the steps of prequalifying for purchase of a lottery ticket for a lottery game by playing a prequalification game that has odds for winning that are substantially equivalent to a current ratio of the local ticket value to the designated base value, and issuing a multi-jurisdictional lottery ticket for the lottery game upon winning the prequalification game. Here, the step of issuing a local lottery ticket for a local lottery game may be made whether or not the prequalification game is won. A step of signaling when the player is authorized to receive the ticket that is valid for the multi-jurisdictional lottery game may be included. The step of prequalifying for purchase of a lottery ticket for a lottery game by playing a prequalification game may include playing a “scratch-off” type video game.

A second alternate embodiment of the method for playing a multi-jurisdictional lottery game is provided which first includes the steps of assigning a designated base value for lottery tickets sold wherein the designated base value is based on a base currency valuation and periodically assigning a local ticket value for lottery tickets sold in each of a plurality of jurisdictions where each jurisdiction has a different monetary system and each local lottery ticket value has a value in local currency that is not equivalent to the designated base value. The method further includes the step of prequalifying for purchase of a lottery ticket for a lottery game wherein a prequalifying event occurs at a ratio substantially equivalent to a current ratio of the local ticket value to the designated base value. Finally, the method includes the steps of issuing a multi-jurisdictional lottery ticket for the lottery game upon the prequalification. The method may include the step of issuing a local lottery ticket for a local lottery game whether or not there has been the prequalifying event. The method may further include the step of signaling when the player has prequalified.

A lottery ticket vending system is also provided which includes player terminals for purchase of at least one lottery ticket where each lottery ticket has a designated base value based on a base currency valuation. The player terminals are located in a multiple jurisdictions each having a different monetary system. A computer network for interconnection of each of the plurality of player terminals and a currency value input device associated with the computer network are also provided to enable periodic input of current currency valuations for each jurisdiction to provide a local lottery ticket value for each of the jurisdictions based on the current currency valuations. The local lottery ticket values are each an equivalent value to the designated base value. A ticket printer to print each of the tickets purchased may be included. The computer network may be a worldwide computer network which uses the internet and/or may use local phone lines. The system may be for a single, multi-jurisdictional lottery utilizing numerous local currencies, where each ticket has an equal value. The tickets may be for a common set of lottery jackpots.

The lottery ticket vending system may include numerous player terminals where each terminal has a central processor and a currency input device for inputting local currency for purchase of at least one lottery ticket. Each lottery ticket has a designated base value based on a base currency valuation and each terminal further having a display screen, a player input device, a ticket printer, and a ticket output device. The player terminals are located in a plurality of jurisdictions having different monetary systems. The system here further includes a central computer system and a computer network for connection of the central processor of each of the player terminals to the central computer system. The central computer system includes a currency value input device to enable periodic input of current currency valuations for each jurisdiction and the central computer system uses the currency values input into the currency value input device to provide a local lottery ticket value for each of the jurisdictions based on the current currency valuations. Here, the local lottery ticket value is an equivalent value to the designated base value. The player input device includes a means to select at least one set of lottery ticket numbers for each of the lottery tickets purchased. The display screen is for displaying the local valuation of currency input into the currency input device in increments of local currency, the base valuation of currency input into the currency input device in increments of base currency, the number of lottery tickets purchasable based on the base valuation of currency input into the currency input device, and/or the sets of lottery ticket numbers selected for each lottery ticket. The ticket printer prints each of the tickets purchased where each ticket includes indicia indicating the at least one set of lottery ticket numbers. The ticket output device delivers the ticket having indicia thereon to the player. Again, the computer network may be a worldwide network which uses the internet and/or local phone lines. The system may sell lottery tickets for a single, multi-jurisdictional lottery utilizing a plurality of local currencies, where each ticket has an equal value. Each of the terminals may sell lottery tickets for a common set of lottery jackpots.

In a first alternate embodiment of the system, the system is for purchasing a lottery ticket for a multi-jurisdictional lottery game where the multi-jurisdictional lottery game is playable in a numerous jurisdictions and is for a common set of lottery jackpots for each player in all of the jurisdictions. The system includes numerous player terminals located in jurisdictions having different monetary systems. The system further includes a computer network for interconnection of each of the player terminals and a base ticket value assigner to assign a base ticket value to lottery tickets sold in a first one of the jurisdictions. The base ticket value uses a base currency of a base currency valuation. The system further includes a local ticket value assigner to assign local ticket values to lottery tickets sold in each remaining jurisdiction where each local ticket value utilizes its own local currency and has its own local currency valuation. A current currency ratio assigner periodically assigns a current ratio of the local currency valuation to the base currency valuation based on foreign currency exchange data for each local ticket value. Finally, the system includes a lottery prequalifier where each player in each the remaining jurisdictions uses the lottery prequalifier to play a prequalification game to qualify to purchase a ticket valid for the multi-jurisdictional lottery game wherein the prequalification game has odds for winning that are substantially equivalent to the current ratio of the local currency valuation to the base currency valuation and wherein each lottery ticket is issuable only upon winning the prequalification game. Here, a printer may be included for printing each of the tickets purchased for each ticket where the prequalification game was won where each ticket includes indicia indicating at least one set of lottery ticket number. The lottery ticket may be usable for a local lottery game whether or not a prequalification game is won. The computer network may be a worldwide network which uses the internet and or local phone lines. The prequalification game is preferably a “scratch-off” type video game.

In a second alternate embodiment of the system, the system is for purchasing a lottery ticket for a multi-jurisdictional lottery game where the game is playable in a plurality of jurisdictions. The system uses a common set of lottery jackpots for each player in all of the plurality of jurisdictions, and includes numerous player terminals located in a multitude of jurisdictions having different monetary systems. The system further includes a computer network for interconnection of each player terminals to the central computer system and a base ticket value assigner to assign a base ticket value to lottery tickets sold in a first one of the jurisdictions where the base ticket value utilizes a base currency of a base currency valuation. The system further includes a local ticket value assigner to assign a local ticket values to lottery tickets sold in each remaining jurisdiction where each local ticket value utilizes its own local currency and has its own local currency valuation. A current ratio assigner for periodically assigning a current ratio of the local currency valuation to the base currency valuation based on foreign currency exchange data is included. Finally, a lottery prequalifier device is included where the prequalifier device allows a lottery ticket valid for the lottery to issue periodically at a rate equal to the current ratio. A ticket printer may be included to print each of the tickets purchased where each ticket includes indicia indicating the lottery ticket numbers. The lottery prequalifier device may include a signal that signals to the player when the player is authorized to receive the ticket that is valid for the multi-jurisdictional lottery game where the prequalifier device and the signal device have a ratio of activation equal to the current ratio of the local currency valuation to the base currency valuation. The signal device may be a signal light that lights only during activation of the prequalifier device. The lottery ticket may be usable for a local lottery game whether or not a prequalification game is won. The computer network may use a worldwide computer network using the internet and or local phone lines. The system may sell lottery tickets for a single, multi-jurisdictional lottery utilizing numerous local currencies, where each ticket has an equal value. Finally, each of the terminals may sell lottery tickets for a common set of lottery jackpots.

### DETAILED DESCRIPTION OF THE INVENTION

The present invention is directed to a lottery ticket vending system that provides a player with high levels of entertainment and excitement as compared to the purchasing of traditional lottery tickets.

The present invention is directed to a traditional lottery system where, periodically, for example, one time per week, one or more winning sets of numbers is selected by a lottery operating organization and one or more jackpot winners are determined based on a comparison of the one or more winning set of numbers with individual lottery ticket numbers. The individual lottery ticket numbers are either player selected or selected by a “quick-pick” feature at the point of purchase, where random lottery ticket numbers are automatically generated.

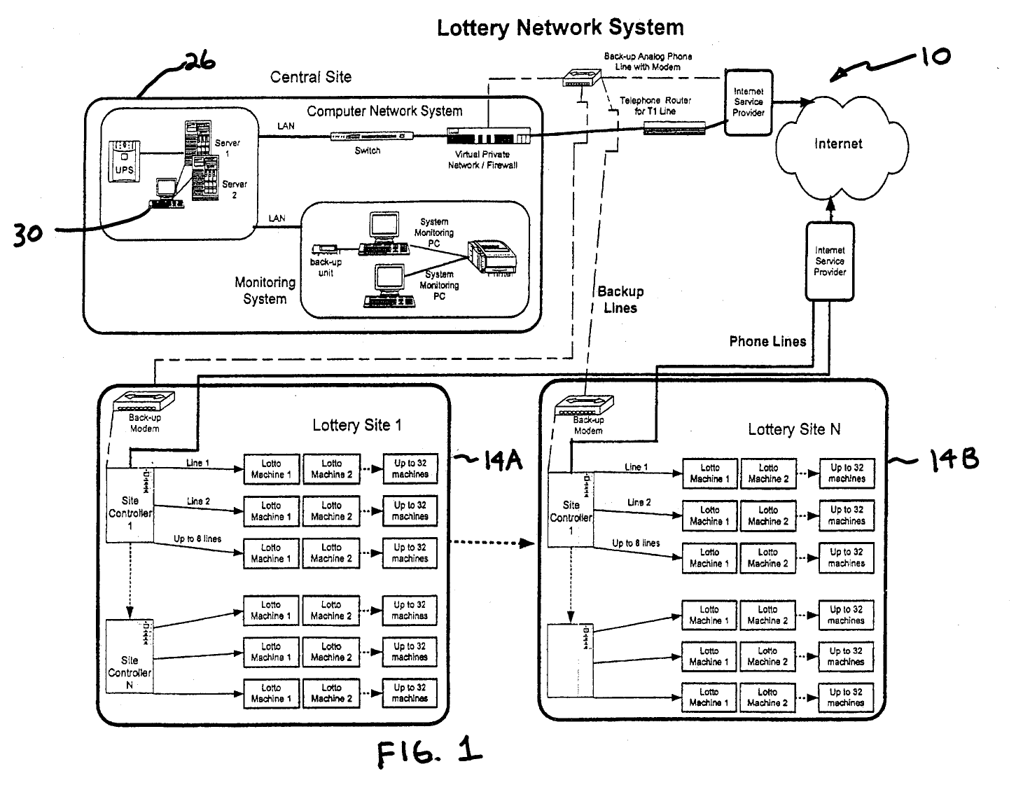

Referring now to the drawing figures wherein like part numbers refer to like elements throughout the several views, there is shown in FIG. 1, a lottery ticket vending system 10 in accordance with one preferred embodiment of the present invention.

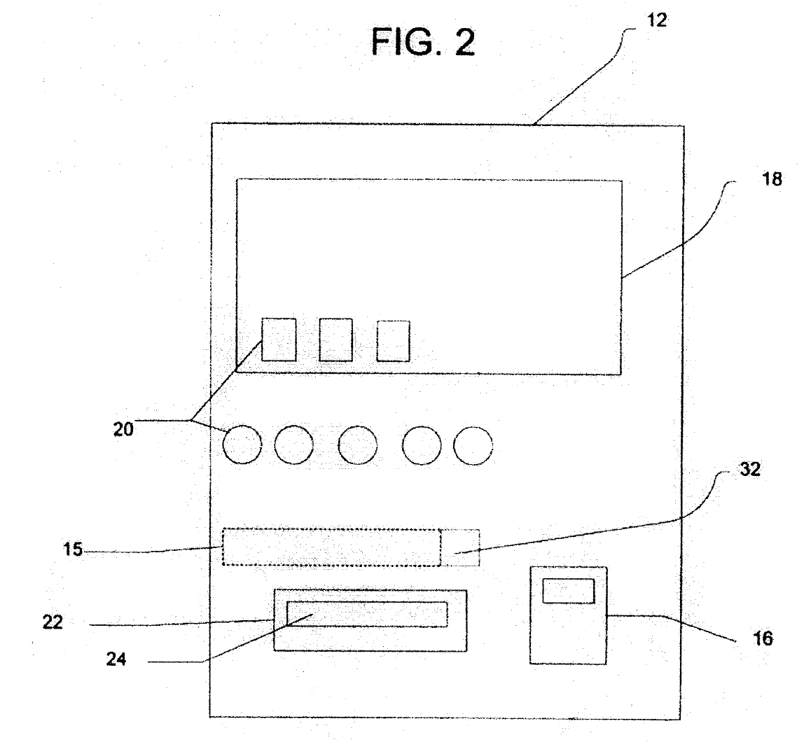

In a first preferred embodiment of the present invention, the lottery ticket vending system 10 of the present invention includes a large set of player terminals 12 (see FIG. 2) located in at least two jurisdictions, for example, jurisdictions 14A, 14B, 14C . . . 14n, having different monetary systems, for example, U.S. dollars, Canadian dollars, Mexican pesos, Japanese yen, etc. As an example, a set of player terminals could be located in the U.S. and a second set of terminals could be located in Japan. It is known that the U.S. monetary system is based on U.S. dollars, while the Japanese monetary system is based on Japanese yen. It is also known that the value of the Japanese yen fluctuates substantially continuously with respect to the U.S. dollar. As seen in FIG. 2, each player terminal 12 has a central processor 15 and a currency input device 16 for inputting local currency for purchase of one or more lottery tickets. Each lottery ticket preferably has a designated value based on a base currency valuation. For example, here, the base currency valuation could be based on the U.S. dollar. Each terminal also has a display screen 18, player input device 20 (which may be in the form of a touch screen as is well known), a ticket printer 22, and a ticket output device 24.

As indicated, each player terminal 12 has a central processor 15. The central processor 15 is in communication with a managing central computer system 26 by a computer network. See FIG. 1. The central computer system 26 includes a currency value input device 30 to enable periodic, for example, hourly, daily, or weekly, input of current currency valuations for each jurisdiction in which a terminal 12 exists. In the above example, the value of the Japanese yen with respect to the U.S. Dollar would be input into the currency value input 30, for example either manually by an operator, or automatically, and is based on daily numbers provided by a bank or other financial institution. The central computer system 26 utilizes the currency values input into the currency value input 30 to provide a local lottery ticket value for each of the jurisdictions based on the current currency valuations. In the above example, at a given time, if a base lottery ticket value is selected to be $1.00 U.S. and the value of the Japanese yen is 132 Yen per U.S. dollar, the local lottery ticket value is 132 yen in Japan while the lottery ticket value in the U.S. is $1.00. 132 yen must be input into the currency input device 16 in Japan. Of course, any number of jurisdictions having different monetary systems can be used. However, each jurisdiction 14A, 14B, . . . 14n, having a different monetary system will have its own local lottery ticket value calculated in a similar manner to that as described above.

The player inserts local currency into the currency input device 16 in an adequate amount to purchase one or more tickets. The player terminal 12 will display the amount required and can preferably provide appropriate change. The player then selects the number of tickets he or she wishes to purchase by selecting an appropriate choice on the player input device 20, on, for example, a touch screen. As indicated, player buttons may be utilized for some or all of the touch screen functions.

The display screen 18 then requests the player to use a player input device 20 to select a set of lottery ticket numbers for each lottery ticket purchased. As is known in the lottery art, the terminal 12 may include a “quick-pick” facility in which the player can request, by, for example, pressing a button or selecting a choice on a touch screen, that the terminal 12 automatically select a set of lottery ticket numbers. The ticket printer 22 then prints out the tickets purchased. Each ticket contains indicia indicating, among other things, the set of lottery ticket numbers. The ticket output device 24 then delivers the ticket having the indicia printed thereon to the player.

Preferably, each player terminal includes a display screen 18 for displaying the number of tickets purchased, the local valuation of currency input into the currency input device 16 in increments of local currency and the base valuation of currency input into the currency input device 16 in increments of base currency. For example, in the above example, if ten tickets valued at $1.00 U.S. each were purchased, and 1320 Japanese yen were input (10 times 132) into the player terminal 12, the player terminal 12 would display “ten tickets purchased” at $10.00, 1320 yen. Additionally, the value of the jackpot or jackpots maybe displayed in both the base currency and the local currency. The display screen 18 would also display the lottery ticket numbers selected for each lottery ticket purchased. The ticket printer 22 would then print out each of the tickets purchased, for example, using a thermal printer where each ticket would include the indicia indicating at least one set of lottery ticket numbers. Each lottery ticket would then be dispensed to the player through the ticket output device 24.

The lottery ticket may be printed, as indicated above, or otherwise be electronically encoded. The ticket may identify, for example, the player's lottery ticket number, a game identifier, an amount of wager, date and time of transaction, and an identification number for the player terminal utilized by the player. The lottery ticket may be used as a bearer instrument for verification and redemption of winnings.

All tickets sold would then be entered into a competition for a single, common jackpot or set of jackpots. The value of the jackpot would be based on the base currency, for example, as above, U.S. currency.

Any quantity of numbers may be used for the set of lottery ticket numbers (and winning set of numbers). For example, the set of numbers could include 6 sets of two digit numbers. Alternatively, the set of numbers could include, for example, between 1 and 10 sets of 1 to 10 digit numbers.

The player's ticket data are preferably communicated to the central computer system 26 which manages operation of the lottery. The player's choices may be registered for the next or a future lottery draw. Preferably, the player's ticket data are recorded.

The computer network preferably operates on a worldwide network such as the internet. However, it is intended that substantially any feasible type of computer network would operate, for example, each player terminal 12 could have a modem connected to dedicated local phone line. Other systems may also be incorporated including, for example, satellite communications.

The lottery ticket vending system 10 may be adapted to sell tickets for substantially any type of lottery. For example, tickets may be sold for a progressive lottery where a lottery jackpot is progressively increased until a set of lottery ticket numbers is identical to a set of winning lottery numbers.

The embodiments described herein are also equally applicable to play with credit cards, debit cards, smart cards and the like as well as with any other type of cashless system known. While it is known that many credit cards issued by banks may be used in countries other than the country in which the card originated. For example, a credit card issued by a U.S. bank may be used to purchase goods and services in a foreign currency. At some point, the issuing bank converts the foreign currency to U.S. dollars for payment by the card holder. In the present invention, however, the purchase would actually be made in the base currency, e.g., U.S. Dollars, rather than the foreign currency.

In a first alternate embodiment, a similar physical system to the embodiment described above may be used, as shown in FIG. 1, including the player terminals 12, currency input device 16 for inputting local currency, a display screen 18, player input device 20, ticket printer 22, ticket output device 24, central processor 24 and computer network. In this embodiment, the central computer system 26 includes the currency value input device 30 to enable periodic input of current currency valuations for each jurisdiction of the plurality of jurisdictions. Here, players in all jurisdictions pay a set amount assigned for the particular jurisdiction. There is no periodic (e.g., day to day) fluctuation of the value of the input required to obtain a lottery ticket.

Here, the central computer system 26 utilizes the currency values input into the currency value input device 30. First, the central computer system 30 includes a base ticket value assigner to assign a base ticket value to lottery tickets sold in a first one of the multiple jurisdictions. The base ticket value is in increments of a base currency. Second, the central computer 26 also includes a local ticket value assigner to assign local ticket values to lottery tickets in all of the other jurisdictions, where each local ticket value utilizes the local currency of the jurisdiction in which the terminal sits. The base ticket value and each local ticket value need not be of equivalent values. Third, the central computer 26 includes a current currency ratio assigner to periodically assign a current ratio of a local currency valuation to a base currency valuation based on foreign currency exchange data, for each local currency where tickets are sold.

Next, the system includes a lottery prequalifier 32 where each player in all jurisdictions other than the players in the jurisdiction using the base ticket value lottery tickets use the lottery prequalifier 32 to play a prequalification game (or other prequalification method) to qualify to purchase a ticket valid for the multi-jurisdictional lottery game wherein the prequalification game has odds for winning that are substantially equivalent to the current ratio of the local currency valuation to the base currency valuation. A lottery ticket that is valid for play in the multi-jurisdictional lottery having the common jackpot is issuable only upon winning the prequalification game.

For example, a base ticket for a multi-jurisdictional lottery is a one dollar ticket in the United States. A common jackpot is available for all participating countries of $1,000,000. Therefore, all participants that purchase a base ticket bet $1.00 for a chance of winning $1,000,000. Mexico would like to sell lottery tickets in the multi-jurisdictional lottery for one Mexican peso. On a given day, the current ratio the value of the peso with respect to the dollar is ten pesos per one dollar (or 10 to 1). Here, the lottery game is set up such that all participants in all countries have substantially the same odds of winning (i.e., for every equivalent of $1.00 bet, there must be essentially the same odds for winning the $1,000,000 jackpot). Therefore, a lottery ticket purchased in pesos would require 10 pesos to have equivalent odds, as described above. However, as indicated above, Mexico would like to sell tickets for only one peso. The present embodiment compensates for this in the following manner.

The base ticket assigner assigns the base ticket value of one U.S. dollar to the lottery tickets sold in the U.S. The local ticket assigner assigns a local (Mexican) ticket value of 1 peso. The current currency ratio assigner determines the current exchange rate of pesos to dollars. Here, the current currency ratio assigns a currency ratio of 1 to 10. Then, the player inserts one peso into the terminal. The terminal then uses the lottery prequalifier to determine whether the player qualifies to play for the multi-jurisdictional lottery. The prequalifier uses the prequalifier game (or other method) where the odds of the player winning are equal to the current currency ratio (in this example: 1 to 10). If the player prequalifies by winning the prequalifier game, then he or she is eligible to obtain a ticket valid for the common jackpot.

For each time a player inputs currency into the currency input device, another chance of winning a lottery or other game may be available. Whether or not the player wins the prequalification game, the terminal may include a game or other device where the player may play a game towards, for example, a local lottery. For example, the player inputs money to purchase a ticket in a local currency. He then selects one or more sets of lottery numbers (for example a set for a local lottery and a set for the multi-jurisdictional lottery having the common jackpot). The player then plays the prequalification game. If the player wins the prequalification game, the player receives a lottery ticket or tickets valid for both the local lottery game and the multi-jurisdictional lottery having the common jackpot. If the player loses the prequalification game, the player receives a lottery ticket valid for only the local lottery game.

In one particularly preferred embodiment, the prequalification game is a video “scratch-off” style game, as well known in the art of gaming. Here, software is used to “position” the various game icons to equalize the opportunity for achieving a winning jackpot for all players in all jurisdictions. The players in all jurisdictions play in substantially the same manner, however, the prequalification software manipulates the icons displayed to equalize everyone in all jurisdictions.

A second alternate embodiment of the system is similar to the first alternate embodiment of the system. Again, the central computer system 26 utilizes the currency values input into the currency value input device 30. First, the central computer system 26 includes a base ticket value assigner to assign a base ticket value to lottery tickets sold in a first one of the multiple jurisdictions. The base ticket value is in increments of a base currency. Second, the central computer also includes a local ticket value assigner to assign local ticket values to lottery tickets in all of the other jurisdictions, where each local ticket value utilizes the local currency of the jurisdiction in which the terminal sits. Third, the central computer system 26 includes a current currency ratio assigner to periodically assign a current ratio of the local currency valuation to the base currency valuation based on foreign currency exchange data, for each local currency where tickets are sold.

Next, a lottery prequalifier device 32, which is preferably integral to each terminal central processor, automatically allows a lottery ticket valid for the multi-jurisdictional lottery having a common jackpot to issue at a rate equal to the current ratio. Here, the terminal may include a signal device (for example, an icon on display 18) that signals the player when he or she is eligible to obtain a ticket valid for the multi-jurisdictional lottery.

For example, in the second alternate embodiment, a base ticket for a multi-jurisdictional lottery is a one dollar ticket in the United States. A common jackpot is available for all participating countries of $1,000,000. Therefore, all participants that purchase a base ticket bet $1.00 for a chance of winning $1,000,000. Mexico would like to sell lottery tickets in the multi-jurisdictional lottery for one Mexican peso. On a given day, the current ratio the value of the peso with respect to the dollar is ten pesos per one dollar (or 10 to 1). Here, the lottery game is set up such that all participants have in all countries have substantially the same odds of winning (i.e., for every equivalent of $1.00 bet, there must be essentially the same odds for winning the $1,000,000 jackpot). Therefore, a lottery ticket purchased in pesos would currently require about 10 pesos to have equivalent odds, as described above. However, as indicated above, Mexico would like to sell tickets for only one peso. The present embodiment compensates for this in the following manner.

The base ticket assigner assigns the base ticket value of one U.S. dollar to the lottery tickets sold in the U.S. The local ticket assigner assigns a local (Mexican) ticket value of 1 peso. The current currency ratio assigner determines the current exchange rate of pesos to dollars. Here, the current currency ratio assigns a currency ratio of 1 to 10. Then, the player inserts one peso into the terminal.

The lottery prequalifier device then uses the current ratio to allow a ticket valid for play in the multi-jurisdictional lottery to issue only 1 out of 10 plays. This may be accomplished, for example, by an indicator icon on the display screen 18 that signals the player that the current ticket that he is purchasing is valid for play in the multi-jurisdictional lottery. As above, all of the plays include the purchase of a ticket for a local lottery or other game of chance.

Although illustrated and described herein with reference to specific embodiments, the present invention nevertheless is not intended to be limited to the details shown. Rather, various modifications may be made in the details within the scope and range of equivalents of the claims without departing from the spirit of the invention.

What is claimed is:

1. A method for playing a multi-jurisdictional lottery game, comprising the steps of:
a) assigning a designated base value for lottery tickets sold wherein the designated base value is based on a base currency valuation;
b) periodically assigning a local ticket value for lottery tickets sold in each of a plurality of jurisdictions, each jurisdiction having a different monetary system, each local lottery ticket value having a value in local currency that is equivalent to the designated base value; and
c) purchasing local lottery tickets in local currency in each of the plurality of jurisdictions;
whereby the step of periodically assigning a local ticket value accounts for variations in currency exchange rates.

2. The method of claim 1, wherein the step of purchasing lottery tickets is for a single, multi-jurisdictional lottery utilizing a plurality of local currencies.

3. The method of claim 1, including the step of selling lottery tickets for a common set of lottery jackpots.

4. A method for playing a multi-jurisdictional lottery game, comprising the steps of:
a) assigning a designated base value for lottery tickets sold wherein the designated base value is based on a base currency valuation;
b) periodically assigning a local ticket value for lottery tickets sold in each of a plurality of jurisdictions, each jurisdiction having a different monetary system, each local lottery ticket value having a value in local currency that is not equivalent to the designated base value;
c) prequalifying for purchase of a lottery ticket for a lottery game by playing a prequalification game that has odds for winning that are substantially equivalent to a current ratio of the local ticket value to said designated base value; and
d) issuing a multi-jurisdictional lottery ticket for the lottery game upon winning the prequalification game.

5. The method of claim 4, including the step of issuing a local lottery ticket for a local lottery game whether or not the prequalification game is won.

6. The method of claim 4, including the step of signaling when the player is authorized to receive the ticket that is valid for the multi-jurisdictional lottery game.

7. The method of claim 4 wherein the step of prequalifying for purchase of a lottery ticket for a lottery game by playing a prequalification game includes playing a “scratch-off” type video game.

8. A method for playing a multi-jurisdictional lottery game, comprising the steps of:
a) assigning a designated base value for lottery tickets sold wherein the designated base value is based on a base currency valuation;
b) periodically assigning a local ticket value for lottery tickets sold in each of a plurality of jurisdictions, each jurisdiction having a different monetary system, each local lottery ticket value having a value in local currency that is not equivalent to the designated base value;
c) prequalifying for purchase of a lottery ticket for a lottery game wherein a prequalifying event occurs at a ratio substantially equivalent to a current ratio of the local ticket value to said designated base value; and
d) issuing a multi-jurisdictional lottery ticket for the lottery game upon the prequalification.

9. The method of claim 8, including the step of issuing a local lottery ticket for a local lottery game whether or not there has been the prequalifying event.

10. The method of claim 8, including the step of signaling when the player has prequalified.

11. A lottery ticket vending system, comprising:
a) a plurality of player terminals for purchase of at least one lottery ticket, each said lottery ticket having a designated base value based on a base currency valuation, said plurality of player terminals located in a plurality of jurisdictions having different monetary systems;
b) a computer network for interconnection of each of said plurality of player terminals; and
c) a currency value input device associated with the computer network to enable periodic input of current currency valuations for each jurisdiction of said plurality of jurisdictions to provide a local lottery ticket value for each of said jurisdictions based on said current currency valuations, said local lottery ticket value each being of an equivalent value to said designated base value.

12. The lottery ticket vending system of claim 11, including a ticket printer to print each of said tickets purchased.

13. The lottery ticket vending system of claim 11, wherein the computer network comprises a worldwide computer network which uses the internet.

14. The lottery ticket vending system of claim 11, wherein the computer network uses local phone lines.

15. The lottery ticket vending system of claim 11, wherein the system is adapted to sell lottery tickets for a single, multi-jurisdictional lottery utilizing a plurality of local currencies, where each ticket has an equal value.

16. The lottery ticket vending system of claim 11, wherein each of the plurality of player terminals is adapted to sell lottery tickets for a common set of lottery jackpots.

17. A lottery ticket vending system, comprising:
a) a plurality of player terminals, each terminal having a central processor, a currency input device for inputting local currency for purchase of at least one lottery ticket, each said lottery ticket having a designated base value based on a base currency valuation, each terminal further having a display screen, a player input device, a ticket printer, and a ticket output device, said plurality of player terminals located in a plurality of jurisdictions having different monetary systems;
b) a central computer system;
c) a computer network for connection of said central processor of each of said plurality of player terminals to said central computer system;
d) said central computer system comprising a currency value input device to enable periodic input of current currency valuations for each jurisdiction of said plurality of jurisdictions, said central computer system adapted to utilize said currency values input into said currency value input device to provide a local lottery ticket value for each of said jurisdictions based on said current currency valuations, said local lottery ticket value each being of an equivalent value to said designated base value;
e) said player input device including means to select at least one set of lottery ticket numbers for each of said lottery tickets purchased;
f) said display screen for displaying:
i) the local valuation of currency input into said currency input device in increments of local currency;
ii) the base valuation of currency input into said currency input device in increments of base currency;
iii) the number of lottery tickets purchasable based on said base valuation of currency input into said currency input device; and
iv) said at least one set of lottery ticket numbers selected for each lottery ticket;
g) said ticket printer adapted to print each of said tickets purchased, each said ticket comprising indicia indicating said at least one set of lottery ticket numbers; and
h) said ticket output device for delivering said ticket having indicia thereon to said player.

18. The lottery ticket vending system of claim 17, wherein the computer network is a worldwide network which uses the internet.

19. The lottery ticket vending system of claim 17, wherein the computer network uses local phone lines.

20. The lottery ticket vending system of claim 17, wherein the system is adapted to sell lottery tickets for a single, multi-jurisdictional lottery utilizing a plurality of local currencies, where each ticket has an equal value.

21. The lottery ticket vending system of claim 17, wherein each of the plurality of player terminals is adapted to sell lottery tickets for a common set of lottery jackpots.

22. A system for purchasing a lottery ticket for a multi-jurisdictional lottery game, said multi-jurisdictional lottery game being playable in a plurality of jurisdictions, said multi-jurisdictional lottery game having a common set of lottery jackpots for each player in all of said plurality of jurisdictions, said system comprising:
a) a plurality of player terminals located in said plurality of jurisdictions having different monetary systems,
b) a computer network for interconnection of each of said plurality of player terminals;
c) a base ticket value assigner to assign a base ticket value to lottery tickets sold in a first one of said plurality of jurisdictions, said base ticket value utilizing a base currency of a base currency valuation;
d) a local ticket value assigner to assign local ticket values to lottery tickets sold in each remaining jurisdiction, each local ticket value utilizing its own local currency and having its own local currency valuation;
e) a current currency ratio assigner to periodically assign a current ratio of said local currency valuation to said base currency valuation based on foreign currency exchange data for each local ticket value; and
f) a lottery prequalifier where each player in each said remaining jurisdictions uses said lottery prequalifier to play a prequalification game to qualify to purchase a ticket valid for the multi-jurisdictional lottery game wherein said prequalification game has odds for winning that are substantially equivalent to said current ratio of said local currency valuation to said base currency valuation, wherein each lottery ticket is issuable only upon winning said prequalification game.

23. The system for purchasing a lottery ticket for a multi-jurisdictional lottery game of claim 22, including a printer for printing each of said tickets purchased for each ticket where said prequalification game was won, each said ticket comprising indicia indicating said at least one set of lottery ticket number.

24. The system for purchasing a lottery ticket for a multi-jurisdictional lottery game of claim 22, wherein the lottery ticket is usable for a local lottery game whether or not a prequalification game is won.

25. The system for purchasing a lottery ticket for a multi-jurisdictional lottery game of claim 22, wherein the computer network is a worldwide network which uses the internet.

26. The system for purchasing a lottery ticket for a multi-jurisdictional lottery game of claim 22, wherein the computer network uses local phone lines.

27. The system for purchasing a lottery ticket for a multi-jurisdictional lottery game of claim 22, wherein the system is adapted to sell lottery tickets for a single, multi-jurisdictional lottery utilizing a plurality of local currencies, where each ticket has an equal value.

28. The system for purchasing a lottery ticket for a multi-jurisdictional lottery game of claim 22, wherein each of the plurality of player terminals is adapted to sell lottery tickets for a common set of lottery jackpots.

29. The system for purchasing a lottery ticket for a multi-jurisdictional lottery game of claim 22, wherein the lottery prequalifier to play a prequalification game is a “scratch-off” type video game.

30. A system for purchasing a lottery ticket for a multi-jurisdictional lottery game, said multi-jurisdictional lottery game being playable in a plurality of jurisdictions, said multi-jurisdictional lottery game having a common set of lottery jackpots for each player in all of the plurality of jurisdictions, the system comprising:
a) a plurality of player terminals located in the plurality of jurisdictions having different monetary systems;
b) a computer network for interconnection of each of the plurality of player terminals to the central computer system;
c) a base ticket value assigner to assign a base ticket value to lottery tickets sold in a first one of the plurality of jurisdictions, the base ticket value utilizing a base currency of a base currency valuation;
d) a local ticket value assigner to assign a local ticket values to lottery tickets sold in each remaining jurisdiction, each local ticket value utilizing its own local currency and having its own local currency valuation;
e) a current ratio assigner for periodically assigning a current ratio of the local currency valuation to the base currency valuation based on foreign currency exchange data; and
f) a lottery prequalifier device, the prequalifier device allowing a lottery ticket valid for the lottery to issue periodically at a rate equal to the current ratio.

31. The system for purchasing a lottery ticket for a multi-jurisdictional lottery game of claim 30, including a ticket printer adapted to print each of the tickets purchased, each the ticket comprising indicia indicating the at least one set of lottery ticket numbers.

32. The system for purchasing a lottery ticket for a multi-jurisdictional lottery game of claim 30, wherein the lottery prequalifier device comprises a signal device that signals to the player when the player is authorized to receive the ticket that is valid for the multi-jurisdictional lottery game, said prequalifier device and said signal device having a ratio of activation equal to the current ratio of the local currency valuation to the base currency valuation.

33. The system for purchasing a lottery ticket for a multi-jurisdictional lottery game of claim 30, wherein the signal device is a signal light that lights only during activation of the prequalifier device.

34. The system for purchasing a lottery ticket for a multi jurisdictional lottery game of claim 30, wherein the lottery ticket is usable for a local lottery game whether or not a prequalification occurs.

35. The system for purchasing a lottery ticket for a multi-jurisdictional lottery game of claim 30, wherein the computer network comprises a worldwide computer network using the internet.

36. The system for purchasing a lottery ticket for a multi-jurisdictional lottery game of claim 30, wherein the computer network comprises local phone lines.

37. The system for purchasing a lottery ticket for a multi-jurisdictional lottery game of claim 30, wherein the system is adapted to sell lottery tickets for a single, multi-jurisdictional lottery utilizing a plurality of local currencies, where each ticket has an equal value.

38. The system for purchasing a lottery ticket for a multi-jurisdictional lottery game of claim 30, wherein each of the plurality of player terminals is adapted to sell lottery tickets for a common set of lottery jackpots.
